(19) United States
(12) Patent Application Publication
(10) Pub. No.: US 2025/0023945 A1
(43) Pub. Date: Jan. 16, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yasuto ISHIBASHI, Kanagawa (JP)

(73) Assignee: FUJIFILM Business Innovation Corp., Tokyo (JP)

(21) Appl. No.: 18/426,366

(22) Filed: Jan. 30, 2024

(30) Foreign Application Priority Data
Jul. 14, 2023 (JP) 2023-116336

(51) Int. Cl. H04L 67/1095

(52) U.S. Cl. CPC H04L 67/1095

(57) ABSTRACT

An information processing system includes at least one memory and at least one processor, wherein the processor is configured to: accept, from an external device, a transmission request containing kinds of data to be transmitted and different transmission times for each kind of data; and transmit data to the external device on the basis of the transmission request.

### CROSS-REFERENCE TO RELATED APPLICATIONS

This application is based on and claims priority under 35 USC 119 from Japanese Patent Application No. 2023-116336 filed Jul. 14, 2023.

### BACKGROUND

### (i) Technical Field

The present disclosure relates to an information processing system, an information processing method, and a non-transitory computer readable medium.

### (ii) Related Art

Japanese Unexamined Patent Application Publication No. 2018-156493 discloses a feature of an information processing device connected through a firewall to a computer on the outside of the firewall, wherein, in querying the computer at a predetermined frequency with a control command for equipment on the inside of the firewall, the frequency of querying the computer is raised in a case where equipment-related data collected from the equipment meets a predetermined condition.

### SUMMARY

Aspects of non-limiting embodiments of the present disclosure relate to providing an information processing system, an information processing method, and a non-transitory computer readable medium in which, when synchronizing data to be recorded in a memory with an external device, communication traffic may be reduced compared to a case of transmitting all data to the external device at the same time without regard for the kinds of data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including at least one memory and at least one processor, wherein the processor is configured to: accept, from an external device, a transmission request containing kinds of data to be transmitted and different transmission times for each kind of data; and transmit data to the external device on the basis of the transmission request.

### BRIEF DESCRIPTION OF THE DRAWINGS

An exemplary embodiment of the present disclosure will be described in detail based on the following figures, wherein:

FIG. 1 is a diagram illustrating a system configuration of a synchronization processing system according to an exemplary embodiment of the present disclosure;

FIG. 2 is a diagram for explaining a synchronization process performed between a cloud server and image forming devices;

FIG. 3 is a block diagram illustrating a hardware configuration of an image forming device according to the exemplary embodiment;

FIG. 4 is a block diagram illustrating a functional configuration of a control device according to the exemplary embodiment;

FIG. 5 is a diagram illustrating a communication frequency table;

FIG. 6 is a block diagram illustrating a functional configuration of a shadow device according to the exemplary embodiment;

FIG. 7 is a flowchart illustrating one example of a process on startup in an image forming device according to the exemplary embodiment;

FIG. 8 is a flowchart illustrating one example of a synchronization process in an image forming device according to the exemplary embodiment;

FIG. 9 is a flowchart illustrating another example of a synchronization process in an image forming device according to the exemplary embodiment;

FIG. 10 is a flowchart illustrating a synchronization process 1, which is an exemplary modification of a synchronization process in an image forming device according to the exemplary embodiment; and

FIG. 11 is a flowchart illustrating a synchronization process 2, which is an exemplary modification of a synchronization process in an image forming device according to the exemplary embodiment.

### DETAILED DESCRIPTION

Hereinafter, an exemplary embodiment of the present disclosure will be described in detail and with reference to the drawings.

### <Synchronization Processing System>

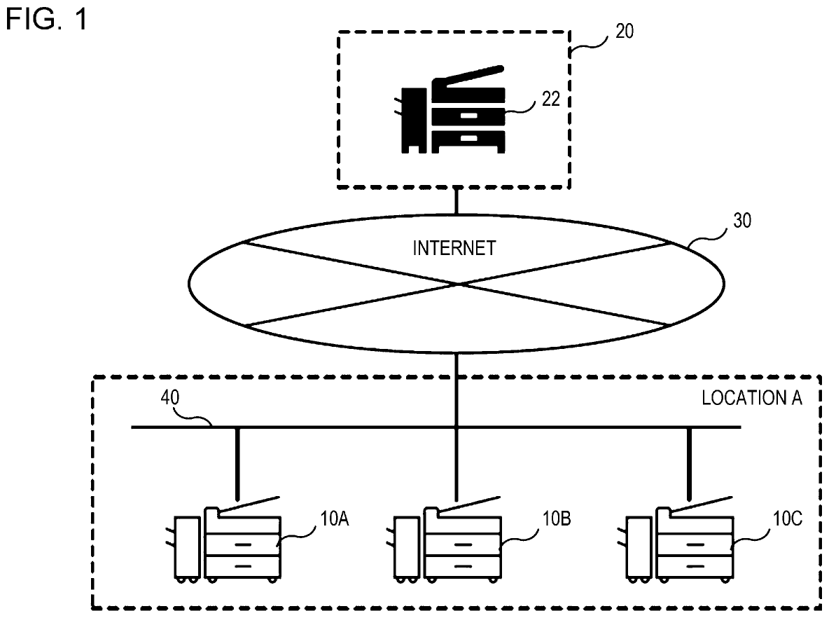

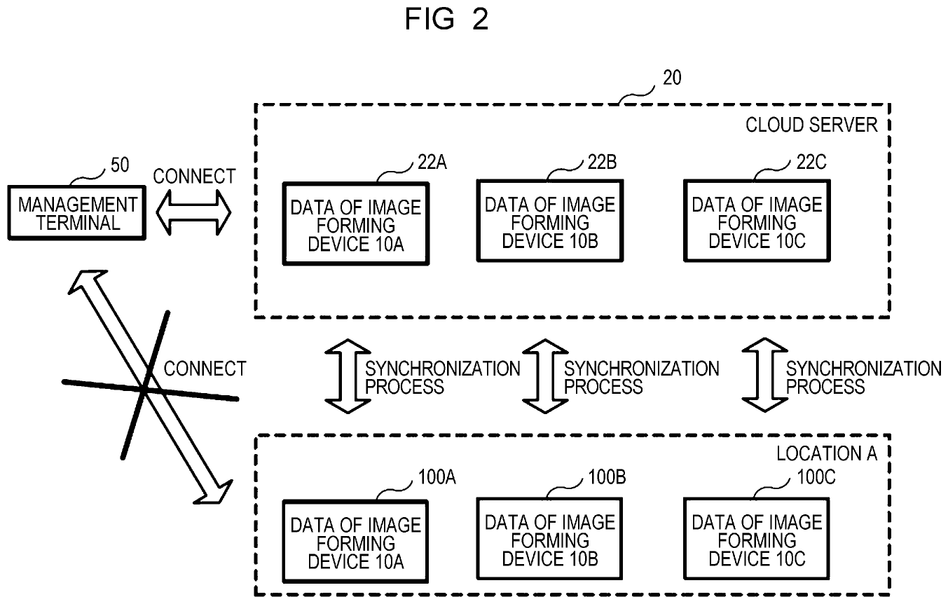

FIG. 1 is a diagram illustrating a system configuration of a synchronization processing system according to an exemplary embodiment of the present disclosure. FIG. 2 is a diagram for explaining a synchronization process performed between a cloud server 20 and image forming devices 10A to 10C.

As illustrated in FIG. 1, a synchronization processing system according to an exemplary embodiment of the present disclosure is configured such that three image forming devices 10A to 10C installed in a location A are connected to a cloud server 20 over the Internet 30. The image forming devices 10A to 10C are interconnected through a network 40 inside the location A. Note that the image forming devices 10A to 10C are each a device referred to as a multi-function device, which includes multiple functions such as a print function, a scan function, a copy function, and a facsimile function. The image forming devices 10A to 10C are each one example of an information processing system in the technology of the present disclosure.

As illustrated in FIG. 2, on the cloud server 20, a shadow device (virtual device) 22 is provided to hold, in synchronization with the image forming devices 10A to 10C, data 100A to 100C pertaining to various settings, statuses, and the like stored in the image forming devices 10A to 10C as physical devices connected over the Internet 30. Specifically, the shadow device 22 on the cloud server 20 stores the data 100A to 100C stored in the image forming devices 10A to 10C as data 22A to 22C while performing a synchronization process with the image forming devices 10A to 10C. Note that the shadow device 22 is one example of an external device in the technology of the present disclosure.

In general, a configuration that allows direct connections to physical devices residing behind a firewall is undesirable from a security standpoint. Accordingly, the synchronization process between the physical devices (image forming devices 10A to 10C) and the shadow device 22 is performed by transmitting the data 100A to 100C stored in the physical devices (image forming devices 10A to 10C) from the physical devices to the shadow device 22 on the cloud server 20.

Using the shadow device 22 in this way allows an external management terminal 50 that manages the physical devices to perform management, such as checking the status of the physical devices and changing settings, through the shadow device 22 in the cloud server 20, even in cases where direct connections to the physical devices to be managed are unavailable. Note that the synchronization process will be described in detail later.

### <Image Forming Devices>

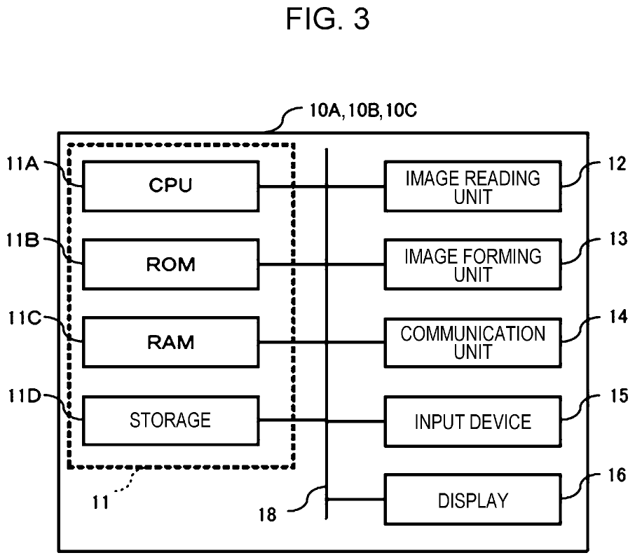

Next, the image forming device 10A in the synchronization processing system according to the exemplary embodiment will be described in detail. Note that although the following description mostly describes operations by the image forming device 10A, the image forming devices 10B, 10C, and the like have a similar configuration. FIG. 3 is a block diagram illustrating a hardware configuration of the image forming device 10A in the exemplary embodiment.

As illustrated in FIG. 3, the image forming device 10A is a device referred to as a multi-function device, and includes multiple functions such as a print function, a scan function, a copy function, and a facsimile function. Specifically, as illustrated in FIG. 3, the image forming device 10A is provided with a control device 11, an image reading unit 12, an image forming unit 13, a communication unit 14, an input device 15, and a display 16. These components are interconnected through a control bus 18.

The image reading unit 12 is a component (for example, a scanner) that reads an image of a document. The image reading unit 12 optically reads and converts an image of a document into a digital signal, thereby generating image data. Note that an image may contain text.

The image forming unit 13 is a component that forms an image onto a recording medium such as paper. The image forming unit 13 forms an image onto a recording medium according to an electrophotographic system in which the steps of charging, exposing, developing, transferring, and fusing are performed, for example. Note that the image forming unit 13 may also form an image onto a recording medium according to another system, such as an inkjet system.

The communication unit 14 is a component for communicating with other equipment, such as the image forming devices 10B, 10C and the shadow device 22 on the cloud server 20. Specifically, the communication unit 14 communicates with other equipment through the use of means of communication such as a wired connection, a wireless connection, the Internet, an intranet, and a public circuit such as a telephone circuit. Note that the means of communication may also be means of communication using sound or speech, light, vibration, images, and the like.

In the exemplary embodiment, the communication unit 14 communicates with the cloud server 20 (shadow device 22) and with the image forming devices 10B, 10C on different networks. Specifically, the communication unit 14 communicates with the image forming devices 10B, 10C through, for example, the closed network 40 (see FIG. 1) that allows a specific image forming device (one example of an information processing system) to connect.

The network 40 is a network with a built-in firewall or other perimeter security system (for example, a LAN or other local network). Communication between the communication unit 14 and the image forming devices 10B, 10C is assumed to be communication that does not require certificate verification, for example.

On the other hand, communication between the communication unit 14 and the cloud server 20 (shadow device 22) is assumed to be communication that requires certificate verification, for example. In the exemplary embodiment, since a firewall or other perimeter security system is present, push delivery from the cloud server 20 (shadow device 22) to the communication unit 14 may be unavailable. Accordingly, pseudo-push communication involving polling from the communication unit 14 to the cloud server 20 (shadow device 22) is performed. That is, the synchronization process is executed through pseudo-push communication.

Note that in the exemplary embodiment, when a query is issued to the cloud server 20 (shadow device 22) from the image forming device 10A through the communication unit 14, the communication unit 14 is configured to receive communication from the cloud server 20 (shadow device 22) as a response to the query.

In the image forming device 10A, a scan process by the scan function is executed by, for example, causing the image reading unit 12 to read an image of a document and generate image data. In the image forming device 10A, a facsimile process by the facsimile function is executed by, for example, transmitting image data generated by reading an image of a document with the image reading unit 12 to another piece of equipment, such as another multi-function device.

In the image forming device 10A, a copy process by the copy function is executed by, for example, causing the image forming unit 13 to form an image onto a recording medium such as paper on the basis of image data generated by reading an image of a document with the image reading unit 12. In the image forming device 10A, a print process by the print function is executed by, for example, causing the image forming unit 13 to form an image onto a recording medium such as paper on the basis of image data obtained from a terminal such as a personal computer or a smartphone, from a storage medium such as USB memory, or the like.

The input device 15 is a component that accepts instructions inputted by the user. Specifically, the input device 15 is configured as input keys (such as a keyboard and operation buttons, for example) and a touch panel on which the user performs input operations, for example.

Instructions given by the user may be execution instructions causing the image forming device 10A to execute a job involving processes such as copy, print, scan, and facsimile processes. A job refers to a unit of processing for operations to be executed according to a single instruction from the user.

The display 16 displays presentation information to be presented to the user. The display 16 may be configured as a liquid crystal display or an organic light-emitting diode display, for example. Note that the display 16 may also function as the input device 15. In this case, the input device is configured as a resistive, capacitive, or other type of touch panel, and the user inputs instructions by performing touch operations, for example.

The control device 11 controls each unit of the image forming device 10A. The control device 11 functions as a computer, and as illustrated in FIG. 3, includes a central processing unit (CPU) 11A, read-only memory (ROM) 11B, random access memory (RAM) 11C, and storage 11D. The CPU 11A, ROM 11B, RAM 11C, and storage 11D are interconnected by the control bus 18.

The CPU 11A is a central processing unit that executes various programs, including information processing programs such as an information synchronization program, and controls each unit. Note that the CPU 11A corresponds to a processor. The ROM 11B stores various programs, including information processing programs, and various data. The RAM 11C temporarily stores programs or data as a work area.

The storage 11D includes a storage medium such as a hard disk drive (HDD), a solid-state drive (SSD), or flash memory, and stores various programs, including an operating system, and various data. The various data includes the data 100A pertaining to various settings, statuses, and the like of the image forming device 10A, and a communication frequency table to be described later. Note that information processing programs may also be stored in the storage 11D. In the exemplary embodiment, the storage 11D corresponds to a memory.

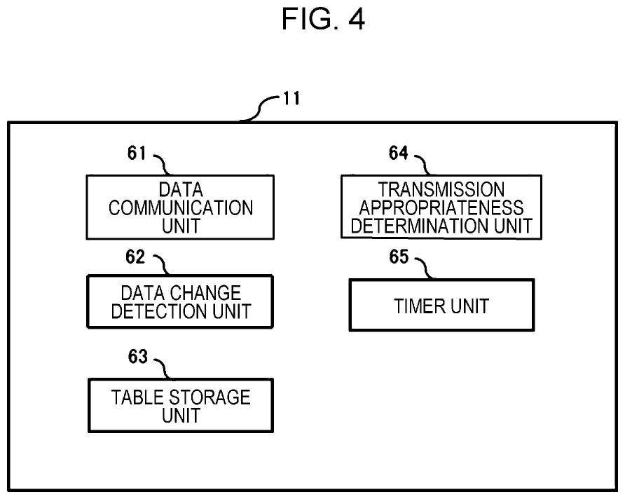

In the control device 11, the CPU 11A reads out various programs, including information processing programs, from the ROM 11B or the storage 11D, and executes the programs while using the RAM 11C as a work area. By executing the information processing programs, the CPU 11A achieves various functions for controlling each unit of the image forming device 10A. Hereinafter, a functional configuration achieved through cooperation between the CPU 11A serving as a hardware resource and the information processing programs serving as a software resource will be described. FIG. 4 is a block diagram illustrating an example of a functional configuration of the control device 11 according to the exemplary embodiment.

In the control device 11, the CPU 11A executes information processing programs to thereby function as a data communication unit 61, a data change detection unit 62, a table storage unit 63, a transmission appropriateness determination unit 64, and a timer unit 65, as illustrated in FIG. 4. The timer unit 65 measures time.

The data communication unit 61 communicates with the shadow device 22 on the basis of a transmission request to be described later, and executes a synchronization process to synchronize information between the image forming device 10A and the shadow device 22. In the exemplary embodiment, the transmission appropriateness determination unit 64 determines whether or not to execute the synchronization process on the basis of the transmission request to be described later, and when the transmission appropriateness determination unit 64 determines to execute the synchronization process, the data communication unit 61 executes the synchronization process. With this arrangement, the data communication unit 61 communicates with the shadow device 22 and executes the synchronization process at a timing based on the transmission request.

“Synchronization process” herein refers to a process of matching the data 100A in the image forming device 10A with the data 22A in the shadow device 22. In the exemplary embodiment, the data 100A pertaining to various settings, statuses, and the like of the image forming device 10A is also retained in the shadow device 22 as the data 22A. Additionally, to resolve differences between the data 100A of the image forming device 10A and the data 22A of the shadow device 22, the data 100A of the image forming device 10A is transmitted to the shadow device 22 to update the data 22A in the shadow device 22.

The data communication unit 61 also stores the data 100A transmitted to the shadow device 22 in the storage 11D, for example.

The data change detection unit 62 detects a change in the data 100A pertaining to various settings, statuses, and the like stored in the image forming device 10A. Specifically, the data change detection unit 62 acquires the data 100A at predetermined intervals and detects a change on the basis of the acquired data 100A. Note that a predetermined number of samples of the data 100A acquired by the data change detection unit 62 are stored in the storage 11D. The data change detection unit 62 detects a change in the data 100A on the basis of the acquired data 100A and the data 100A last stored in the storage 11D. The data change detection unit 62 also detects a change in the data 100A on the basis of the acquired data 100A and the data 100A last stored in the storage 11D and already transmitted to the shadow device 22.

The table storage unit 63 stores information indicating a “transmission request”. In the exemplary embodiment, a “transmission request” is transmitted from the shadow device 22, for example. The information indicating a “transmission request” includes kinds of the data 100A to be transmitted from the image forming device 10A to the shadow device 22 and transmission times (that is, a data communication frequency) which is different for each kind of data 100A. Specifically, the table storage unit 63 stores a communication frequency table, to be described later, as the information indicating a “transmission request”. Note that the table storage unit 63 according to the exemplary embodiment is provided in the storage 11D, for example.

The transmission appropriateness determination unit 64 determines whether or not to perform the process of synchronization with the shadow device 22, that is, to transmit the data 100A to the shadow device 22. Specifically, the transmission appropriateness determination unit 64 determines whether or not a timing at which to transmit the data 100A has been reached, on the basis of a change in the data 100A detected by the data change detection unit 62 and the communication frequency table stored in the table storage unit 63.

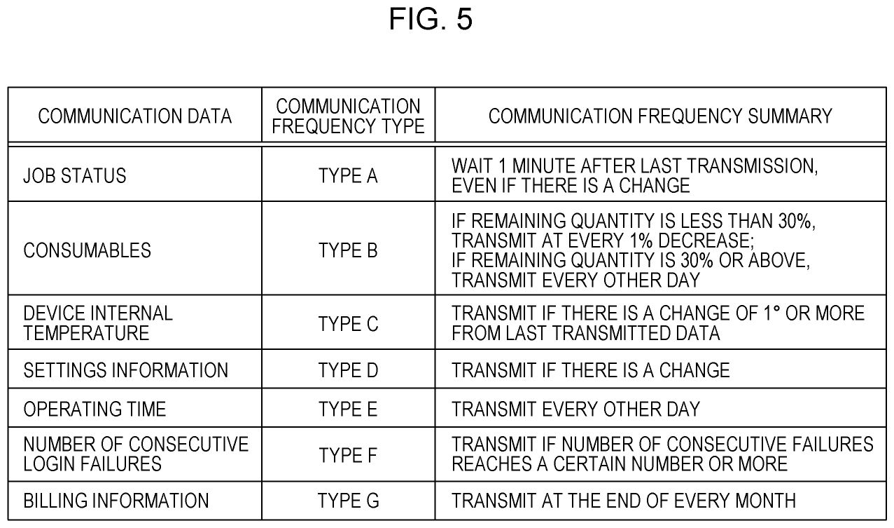

FIG. 5 is a diagram illustrating the communication frequency table. As illustrated in FIG. 5, in the communication frequency table, a communication frequency type indicating the communication frequency is set for each kind of communication data. Note that in FIG. 5, a “communication frequency summary” is indicated in the communication frequency table, but in actuality, the kinds of communication data and the communication frequency types may simply be indicated. That is, the communication frequency for each communication frequency type may be stored, in association with each communication frequency type, in advance in the storage 11D, for example.

The communication frequency (transmission times) includes a communication frequency determined according to a change in the data 100A and a communication frequency determined by a setting value set in the image forming device 10A. In FIG. 5, the communication frequency determined according to a change in the data 100A includes a “type A” set for “job status”, a “type B” set for “consumables”, a “type C” set for “device internal temperature”, and a “type F” set for “number of consecutive login failures”. In addition, the communication frequency determined by a setting value set in the image forming device 10A includes a “type D” set for “settings information”. The communication frequency (transmission times) also includes a communication frequency determined according to the kind of data, irrespective of a change in the data 100A, and this communication frequency includes a “type E” set for “operating time” and a “type G” set for “billing information”.

In “type A”, times determined according to a change in the data 100A acquired in the image forming device 10A and the elapsed time since the change occurred are set as the communication frequency. Specifically, for “job status”, the communication frequency is set to “wait 1 minute after last transmission, even if there is a change”.

In “type B”, times determined according to the remaining quantity of consumables which are consumed in the image forming device 10A are set as the communication frequency. Specifically, for “consumables”, the communication frequency is set to “if remaining quantity is less than 30%, transmit at every 1% decrease; if remaining quantity is 30% or above, transmit every other day”. That is, when the remaining quantity is at or above a predetermined setting value of 30%, the communication frequency is set lower than when the remaining quantity is less than the predetermined setting value of 30%.

In “type C”, transmission times at which a predetermined change from the data 100A last transmitted to the shadow device 22 occurs in the data 100A acquired in the image forming device 10A are set as the communication frequency. Specifically, for “device internal temperature”, the communication frequency is set to “transmit if there is a change of 1° or more from last transmitted data”.

In “type D”, times determined according to a setting value set in the image forming device 10A are set as the communication frequency. “Settings information” may be, for example, the version of Transport Layer Security (TLS), a protocol for communications in which security is desirable on a computer network such as the Internet. Specifically, for “settings information”, the communication frequency is set to “transmit if there is a change”.

In “type E”, times determined according to the kind of data 100A, irrespective of a change in the data 100A, are set as the communication frequency. “Operating time” is a value indicating the cumulative total time during which scan processes, facsimile processes, copy processes, and print processes are actually executed while the image forming device 10A is running. Specifically, for “operating time”, “transmit every other day” is set. That is, the synchronization process is performed on alternate days.

In “type F”, transmission times at which an accumulative value of the data 100A acquired in the image forming device 10A becomes equal to or greater than a predetermined value are set as the communication frequency. Specifically, for the “number of consecutive login failures”, which is number of consecutive failures by a user to log in to the image forming device 10A, the communication frequency is set to “transmit if number of consecutive failures reaches a certain number or more”.

In “type E”, times determined according to the kind of data 100A, irrespective of a change in the data 100A, are set as the communication frequency. “Billing information” is information related to the charging of fees, and includes a number of pages scanned, a number of pages sent by facsimile, a number of pages copied, and a number of pages printed, for example. Specifically, for “billing information”, “transmit at the end of every month” is set.

### <Shadow Device>

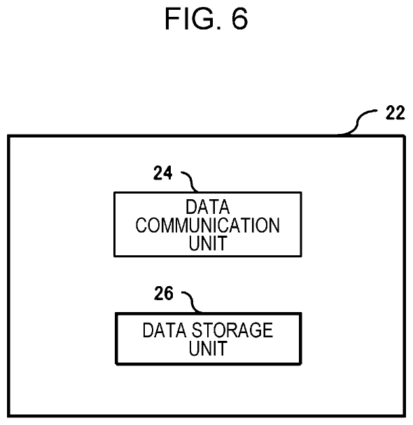

Next, the shadow device 22 in the synchronization processing system according to the exemplary embodiment will be described in detail. FIG. 6 is a block diagram illustrating a functional configuration of the shadow device 22 in the exemplary embodiment.

The shadow device 22 is an example of a synchronization destination for the image forming devices 10A to 10C. The shadow device 22 is a device constructed virtually on the cloud server 20. As described above, the shadow device 22 is capable of communicating with the image forming devices 10A to 10C by pseudo-push communication.

As illustrated in FIG. 6, the shadow device 22 is provided with a data communication unit 24 and a data storage unit 26 as functional units.

The data communication unit 24 functions as a transmission unit that transmits the communication frequency table, which serves as information indicating a “transmission request”, to the image forming devices 10A to 10C. The data communication unit 24 also functions as a reception unit that receives the data 100A to 100C transmitted from the image forming devices 10A to 10C. Specifically, the data communication unit 24 communicates with the image forming devices 10A to 10C through the use of means of communication such as a wired connection, a wireless connection, the Internet, an intranet, and a public circuit such as a telephone circuit. Note that the means of communication may also be means of communication using sound or speech, light, vibration, images, and the like.

The data storage unit 26 stores the communication frequency table serving as information indicating a “transmission request”, and the data 100A to 100C transmitted from the image forming devices 10A to 10C, as the data 22A of the image forming device 10A, the data 22B of the image forming device 10B, and the data 22C of the image forming device 10C (see FIG. 2). Note that the data storage unit 26 may be provided in storage (not illustrated) forming a control device (not illustrated) in the cloud server 20, for example. The storage, similarly to the storage 11D of the image forming device 10A, includes a storage medium such as a hard disk drive (HDD), a solid-state drive (SSD), or flash memory.

### <Process Flow in Image Forming Devices>

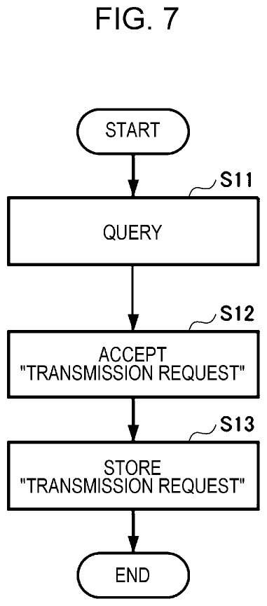

Next, the flow of a process executed in the image forming devices 10A to 10C of the exemplary embodiment will be described. Note that the following describes only the flow of the synchronization process executed in the image forming device 10A as an example, but similar processes are also executed in the image forming devices 10B and 10C. FIG. 7 is a flowchart illustrating one example of a process on startup in an image forming device 10 according to the exemplary embodiment.

As illustrated in FIG. 7, when the image forming device 10A is powered on and begins to operate, first, in step S11, the control device 11 of the image forming device 10A queries the shadow device 22 via the communication unit 14. Specifically, the control device 11 requests the shadow device 22 to transmit a “transmission request”. The “transmission request” is, for example, the communication frequency table.

In response to the query from the image forming device 10A in step S11, the shadow device 22 transmits a “transmission request” to the image forming device 10A via the data communication unit 24. That is, the shadow device 22 transmits, to the image forming device 10A, information on the kinds of data 100A and the transmission times (that is, communication frequency) that differ for each kind of data 100A included in the communication frequency table (see FIG. 5) serving as a “transmission request”.

In step S12, the control device 11 of the image forming device 10A accepts, via the communication unit 14, the “transmission request” transmitted by the shadow device 22. Specifically, the control device 11 accepts the communication frequency table serving as a “transmission request”.

Next, in step S13, the control device 11 stores the “transmission request” accepted in step S12 in the table storage unit 63, and ends the process. At this point, if a communication frequency table serving as a “transmission request” is already stored in the table storage unit 63, the control device 11 updates the stored communication frequency table.

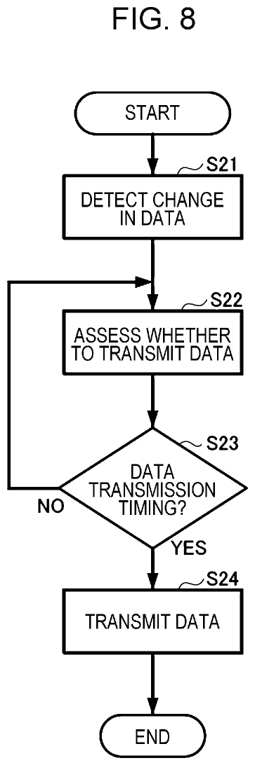

Next, the flow of the synchronization process executed in the image forming device 10A of the exemplary embodiment will be described. FIG. 8 is a flowchart illustrating one example of the synchronization process in the image forming device 10A according to the exemplary embodiment. Note that the synchronization process illustrated in FIG. 8 starts after the process on startup of the image forming device 10A illustrated in FIG. 7 ends, and is repeated until the image forming device 10A is powered off. Also, the synchronization process illustrated in FIG. 8 is performed for each kind of data 100A that is transmitted. In the exemplary embodiment, the synchronization process is executed by causing the CPU 11A of the image forming device 10A to read out an information processing program from the ROM 11B or the storage 11D and execute the information processing program.

When the process on startup of the image forming device 10A illustrated in FIG. 7 ends, in step S21, the data change detection unit 62 acquires the data 100A and detects a change in the acquired data 100A as described above.

Next, in step S22, the transmission appropriateness determination unit 64 determines the appropriateness of transmission of the data 100A. Specifically, the transmission appropriateness determination unit 64 determines whether or not a timing for transmission of the data 100A has been reached, on the basis of the communication frequency table stored in the table storage unit 63. In step S23, if the transmission appropriateness determination unit 64 determines that a timing at which to transmit the data 100A to the shadow device 22 has been reached (step S23; YES), the data communication unit 61 transmits the acquired data 100A to the shadow device 22 and ends the process.

Note that the data communication unit 24 of the shadow device 22 stores the data 100A transmitted by the data communication unit 61 of the image forming device 10A in the data storage unit 26 as the data 22A. That is, the data 22A that had been stored in the data storage unit 26 is updated.

On the other hand, in step S23, if the transmission appropriateness determination unit 64 determines that a timing at which to transmit the acquired data 100A to the shadow device 22 has not been reached (step S23; NO), the CPU 11A goes to step S22 and repeats the process from step S22 until a timing at which to transmit the acquired data 100A to the shadow device 22 is reached.

As an example, in the case in which the data 100A is “job status”, the communication frequency is set to “type A”. As described above, “job status” is data indicating how many jobs have been accepted and how many jobs have been executed currently according to user instructions inputted via the input device 15. For example, in the case in which print processes are to be performed in the image forming device 10A, “job status” is data indicating information that, for example, the printing of 10 pages has been accepted, of which three pages have been printed; specifically, “job status” is data representing “3/10”.

That is, in FIG. 8, when the data change detection unit 62 detects a change in the data from “3/10” to “4/10” in step S21, the transmission appropriateness determination unit 64 determines the appropriateness of transmission of the data 100A in step S22. The appropriateness of transmission of the data 100A is determined on the basis of the “type A” communication frequency of “wait 1 minute after last transmission, even if there is a change” indicated in the communication frequency table stored in the table storage unit 63.

Specifically, the data communication unit 61 carries out transmission after 1 minute elapses from the last (most recent) synchronization process (transmission). In other words, even though the data change detection unit 62 detects a change in the data from “3/10” to “4/10”, transmission is not carried out if 1 minute has not elapsed since the last synchronization process by the data communication unit 61.

Consequently, in step S23 of FIG. 8, if the measured time since the last synchronization process measured by the timer unit 65 is less than 1 minute, the transmission appropriateness determination unit 64 determines that a data transmission timing has not been reached (step S23; NO), and repeats the process from step S22 until a data transmission timing is reached. On the other hand, in step S23, if the measured time since the last synchronization process measured by the timer unit 65 is 1 minute or more, the transmission appropriateness determination unit 64 determines that a data transmission timing has been reached (step S23; YES). The data communication unit 61 then transmits the data 100A indicating “4/10” to the shadow device 22.

As another example, in the case in which the data 100A is “consumables”, the communication frequency is set to “type B”. “Consumables” include, for example, paper (not illustrated) stocked in the image forming device 10A, toner (not illustrated) included in the image forming unit 13, and a scanner drum (not illustrated) included in the image reading unit 12. In the case in which the “consumables” are paper, data based on the number of currently stocked sheets as a remaining quantity serves as the communication data, and in the case in which, for example, the image forming device 10A is capable of stocking 100 pages of paper and the remaining quantity is 30 sheets, data representing “30%” as an example serves as the communication data.

In the case in which the “consumables” are toner, the remaining quantity of toner serves as the communication data. Note that the remaining quantity of toner may be detected by, for example, deriving from the number of prints up to the present, deriving from the weight of the toner, or a known method may be used.

In the case in which the “consumables” are a scanner drum, data on remaining quantity derived on the basis of the film thickness of a protective layer (not illustrated) on the scanner drum surface serves as the communication data, for example. The film thickness may be measured according to a known method.

That is, when the data change detection unit 62 detects a change in the remaining quantity of the “consumables” in step S21 of FIG. 8, the transmission appropriateness determination unit 64 determines the appropriateness of transmission of the data 100A in step S22. The appropriateness of transmission of the data 100A is determined on the basis of the “type B” communication frequency of “if remaining quantity is less than 30%, transmit at every 1% decrease; if remaining quantity is 30% or above, transmit every other day” indicated in the communication frequency table stored in the table storage unit 63.

Specifically, if the remaining quantity is less than 30%, the data communication unit 61 performs the synchronization process (transmission) at every 1% decrease in the remaining quantity. If the remaining quantity is 30% or above, the data change detection unit 62 performs the synchronization process (transmission) every other day, that is, every time 48 hours elapses.

Consequently, in step S23 of FIG. 8, if the remaining quantity is less than 30% and the decrease in the remaining quantity is less than 1%, the transmission appropriateness determination unit 64 determines that a data transmission timing has not been reached (step S23; NO), and repeats the process from step S22 until a data transmission timing is reached. On the other hand, if the remaining quantity is less than 30% and the remaining quantity has decreased by 1%, for example, the transmission appropriateness determination unit 64 determines that a data transmission timing has been reached (step S23; YES). The data communication unit 61 then transmits the data 100A indicating the remaining quantity most recently acquired by the data change detection unit 62 to the shadow device 22.

Otherwise, in step S23, if the remaining quantity is 30% or above and the measured time since the time of the process performed in step S21 measured by the timer unit 65 is less than 48 hours, the transmission appropriateness determination unit 64 determines that a data transmission timing has not been reached (step S23; NO), and repeats the process from step S22 until a data transmission timing is reached. If the remaining quantity is 30% or above and the measured time since the last synchronization process measured by the timer unit 65 is 48 hours or more, the transmission appropriateness determination unit 64 determines that a data transmission timing has been reached (step S23; YES). The data communication unit 61 then transmits the data 100A indicating the remaining quantity most recently acquired by the data change detection unit 62 to the shadow device 22.

As another example, in the case in which the data 100A is “device internal temperature”, the communication frequency is set to “type C”. “Device internal temperature” is, for example, the temperature detected by a temperature sensor (not illustrated) provided inside the image forming device 10A.

That is, when the data change detection unit 62 detects a change in the “device internal temperature” in step S21 of FIG. 8, the transmission appropriateness determination unit 64 determines the appropriateness of transmission of the data in step S22. The appropriateness of transmission of the data is determined on the basis of the “type C” communication frequency of “transmit if there is a change of 1° or more from last transmitted data” indicated in the communication frequency table stored in the table storage unit 63.

Specifically, the data communication unit 61 performs the synchronization process (transmission) when the data change detection unit 62 detects that the temperature indicated by a value outputted from the temperature sensor has changed by 1° or more from the data 100A last transmitted to the shadow device 22.

Consequently, in step S23 of FIG. 8, if a change of less than 1° between the device internal temperature and the temperature indicated by the last transmitted data 100A stored in the storage 11D is detected by the data change detection unit 62 in step S21, the transmission appropriateness determination unit 64 determines that a data transmission timing has not been reached (step S23; NO), and repeats the process from step S22 until a data transmission timing is reached. On the other hand, if a change of 1° or more between the device internal temperature and the temperature indicated by the last transmitted data 100A stored in the storage 11D is detected by the data change detection unit 62 in step S21, the transmission appropriateness determination unit 64 determines that a data transmission timing has been reached (step S23; YES). The data communication unit 61 then transmits the data 100A indicating the device internal temperature most recently acquired by the data change detection unit 62 to the shadow device 22.

As another example, in the case in which the data 100A is “settings information”, the communication frequency is set to “type D”. Note that the “settings information” herein is assumed to be information indicating the TLS version, for example. When the data change detection unit 62 detects a change in the “settings information” in step S21 of FIG. 8, the transmission appropriateness determination unit 64 determines the appropriateness of transmission of the data in step S22. The appropriateness of transmission of the data is determined on the basis of the “type D” communication frequency of “transmit if there is a change” indicated in the communication frequency table stored in the table storage unit 63.

That is, if the data change detection unit 62 detects a change in the TLS version in step S21, the transmission appropriateness determination unit 64 determines that a data transmission timing has been reached in step S23 (step S23; YES). The data communication unit 61 then transmits the data 100A indicating the TLS version most recently acquired by the data change detection unit 62 to the shadow device 22.

As another example, in the case in which the data 100A is “number of consecutive login failures”, the communication frequency is set to “type F”. “Number of consecutive login failures” is, for example, an accumulative value counted by a counter (not illustrated) provided in the control device 11 of the image forming device 10A.

That is, when the data change detection unit 62 detects a change in the “number of consecutive login failures” in step S21 of FIG. 8, the transmission appropriateness determination unit 64 determines the appropriateness of transmission of the data in step S22. The appropriateness of transmission of the data is determined on the basis of the “type F” communication frequency of “transmit if number of consecutive failures reaches a certain number or more” indicated in the communication frequency table stored in the table storage unit 63. Note that in the exemplary embodiment, the “certain number” is set to 3 times, for example.

Specifically, the data communication unit 61 performs the synchronization process (transmission) when the data change detection unit 62 detects that the accumulative value outputted from the counter is 3 times or more.

Consequently, in step S23 of FIG. 8, if the accumulative value outputted from the counter is detected to be less than 3 times by the data change detection unit 62 in step S21, the transmission appropriateness determination unit 64 determines that a data transmission timing has not been reached (step S23; NO), and repeats the process from step S22 until a data transmission timing is reached. On the other hand, if the accumulative value outputted from the counter is detected to be 3 times or more by the data change detection unit 62 in step S21, the transmission appropriateness determination unit 64 determines that a data transmission timing has been reached (step S23; YES). The data communication unit 61 then transmits the data 100A indicating the number of consecutive login failures most recently acquired by the data change detection unit 62 to the shadow device 22.

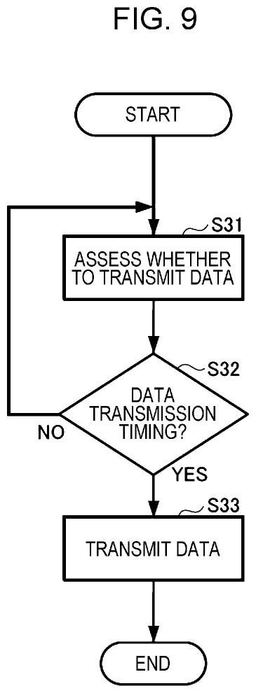

Next, another example of the flow of the synchronization process executed in the image forming device 10A of the exemplary embodiment will be described. FIG. 9 is a flowchart illustrating another example of the synchronization process in the image forming device 10A according to the exemplary embodiment. Note that, like the synchronization process described above, the synchronization process illustrated in FIG. 9 starts after the process on startup of the image forming device 10A illustrated in FIG. 7 ends, and is repeated until the image forming device 10A is powered off. Also, the synchronization process illustrated in FIG. 9 is performed for each kind of data that is transmitted. In the exemplary embodiment, the synchronization process is executed by causing the CPU 11A of the image forming device 10A to read out an information processing program from the ROM 11B or the storage 11D and execute the information processing program.

When the process on startup of the image forming device 10A illustrated in FIG. 7 ends, in step S31, the transmission appropriateness determination unit 64 determines the appropriateness of transmission of the data 100A. Specifically, the transmission appropriateness determination unit 64 determines whether or not a timing for transmission of the data 100A has been reached, on the basis of the communication frequency table stored in the table storage unit 63. In step S32, if the transmission appropriateness determination unit 64 determines that a timing at which to transmit the data 100A to the shadow device 22 has been reached (step S32; YES), the data communication unit 61 transmits the data 100A to the shadow device 22 and ends the process. That is, in the synchronization process in FIG. 9, the synchronization process is performed on a communication frequency according to the kind of data 100A, irrespective of a change in the data 100A.

As an example, in the case in which the data 100A is “operating time”, the communication frequency is set to “type E”. As described above, “operating time” is a value indicating the cumulative total time during which scan processes, facsimile processes, copy processes, and print processes are actually executed while the image forming device 10A is running.

That is, in step S31 of FIG. 9, the transmission appropriateness determination unit 64 determines the appropriateness of transmission of the data 100A on the basis of the “type E” communication frequency of “transmit every other day” indicated in the communication frequency table stored in the table storage unit 63. In step S32, if the measured time since the last synchronization process measured by the timer unit 65 is less than 48 hours, the transmission appropriateness determination unit 64 determines that a data transmission timing has not been reached (step S32; NO), and repeats the process from step S31 until a data transmission timing is reached. If the measured time since the last synchronization process measured by the timer unit 65 is 48 hours or more, the transmission appropriateness determination unit 64 determines that a data transmission timing has been reached (step S32; YES). The data communication unit 61 then transmits the data 100A indicating the operating time to the shadow device 22.

Note that in the exemplary embodiment, as an example, the “operating time” is measured by the timer unit 65, and when the synchronization process is performed, the data 100A transmitted to the shadow device 22 is stored in the storage 11D and the measurement by the timer unit 65 is reset.

As another example, in the case in which the data 100A is “billing information”, the communication frequency is set to “type G”. As described above, “billing information” is information related to the charging of fees, and includes a number of pages scanned, a number of pages sent by facsimile, a number of pages copied, and a number of pages printed, for example.

That is, in step S31 of FIG. 9, the transmission appropriateness determination unit 64 determines the appropriateness of transmission of the data 100A on the basis of the “type G” communication frequency of “transmit at the end of every month” indicated in the communication frequency table stored in the table storage unit 63. In step S32, if the date and time set by the control device 11 is not the end of the month, the transmission appropriateness determination unit 64 determines that a data transmission timing has not been reached (step S32; NO), and repeats the process from step S31 until a data transmission timing is reached. If the date and time set by the control device 11 is the end of the month, the transmission appropriateness determination unit 64 determines that a data transmission timing has been reached (step S32; YES). The data communication unit 61 then transmits the data 100A indicating the billing information acquired by the data change detection unit 62 to the shadow device 22.

Note that in the exemplary embodiment, as an example, the “billing information”, namely a number of pages scanned, a number of pages sent by facsimile, a number of pages copied, a number of pages printed, and the like is measured by the timer unit 65. When the synchronization process is performed, the data 100A transmitted to the shadow device 22 is stored in the storage 11D and the measurement by the timer unit 65 is reset.

### <Action According to Exemplary Embodiment>

In the image forming devices 10A to 10C of the exemplary embodiment, the data communication unit 61 accepts a communication frequency table as a transmission request from the shadow device 22, and transmits the data 100A to 100C recorded in the storage 11D to the shadow device 22 on the basis of the communication frequency table. In the communication frequency table, the kinds of the data 100A to 100C to be transmitted and different transmission times for each kind of data 100A to 100C are set, and therefore the data communication unit 61 transmits the data 100A to 100C at different timings for each kind of data 100A to 100C. Accordingly, when synchronizing the data 100A to 100C recorded in the storage 11D with the shadow device 22, the communication traffic may be reduced compared to the case of transmitting all of the data 100A to 100C to the shadow device 22 at the same time, irrespective of the kinds of the data 100A to 100C.

The image forming devices 10A to 10C of the exemplary embodiment transmit the data 100A to 100C to the shadow device 22 at transmission times, or in other words timings, determined according to a change in the data 100A to 100C. Accordingly, for one kind of data 100A to 100C, the communication traffic may be reduced compared to the case of transmitting the data 100A to 100C periodically.

In the image forming devices 10A to 10C of the exemplary embodiment, as in the case in which the data 100A is “job status”, for example, the data 100A is transmitted after waiting for 1 minute since the last transmission to the shadow device 22, even if there is a change in the data 100A. In this way, even when there is a change in the data 100A to 100C, the data 100A to 100C is not transmitted immediately, and thus the communication traffic may be reduced due to a reduction in the communication frequency of the data 100A to 100C.

In the image forming devices 10A to 10C of the exemplary embodiment, as in the case in which the data 100A is “device internal temperature”, for example, the data 100A is transmitted when there is a change of 1° or more from the data 100A last transmitted to the shadow device 22. In this way, the data 100A to 100C is transmitted only when there is a predetermined change from the data 100A to 100C last transmitted, and thus the communication traffic may be reduced due to a reduction in the communication frequency of the data 100A to 100C.

In the image forming devices 10A to 10C of the exemplary embodiment, as in the case in which the data 100A is “consumables”, for example, the data 100A to 100C is transmitted to the shadow device 22 at timings determined according to the remaining quantity of consumables. Accordingly, unnecessary transmissions may be suppressed and thus communication traffic may be reduced compared to the case of transmitting the data 100A to 100C periodically.

Further, in the image forming devices 10A to 10C of the exemplary embodiment, for example, when the remaining quantity is at or above a predetermined threshold value, the communication frequency is lowered compared to when the remaining quantity is less than the threshold value. Accordingly, unnecessary transmissions may be suppressed and thus communication traffic may be reduced compared to the case of transmitting the data 100A to 100C periodically.

In the image forming devices 10A to 10C of the exemplary embodiment, in the case in which the data 100A is data indicating the TLS version as “settings information”, for example, the data 100A to 100C is transmitted to the shadow device 22 when the version is changed. In this way, the data 100A to 100C is transmitted only when the setting value is changed, and thus the communication traffic may be reduced compared to the case of transmitting the data 100A to 100C periodically.

### Exemplary Modifications

Note that in the exemplary embodiment above, in the case in which the data 100A is “consumables”, when the remaining quantity is at or above a predetermined threshold value, the communication frequency is lowered compared to when the remaining quantity is less than the threshold value, but the technology of the present disclosure is not limited thereto. Even if the remaining quantity is at or above a predetermined threshold value, the communication frequency may be raised when the rate of decrease in the remaining quantity exceeds a predetermined threshold value. The “rate of decrease in the remaining quantity” indicates the amount (for example, 10%) by which the remaining quantity decreases per a unit time (for example, 60 minutes).

Specifically, for example, the communication frequency may be defined as follows: “Transmit at every 2% decrease if remaining quantity is less than 30% and transmit every other day if remaining quantity is 30% or above. However, even if remaining quantity is 30% or above, transmit at every 1% decrease or every other minute if rate of decrease in remaining quantity exceeds 50%.” With this arrangement, when the remaining quantity of consumables is greater than a threshold value but the rate of decrease in the remaining quantity is equal to or greater than a predetermined threshold value, the communication frequency is raised compared to the case of being less than the threshold value, thereby suppressing missed transmissions of relevant data 100A.

In the exemplary embodiment above, in the case in which the data 100A is “device internal temperature”, the data 100A is transmitted when there is a change of 1° or more from the data 100A last transmitted to the shadow device 22, but the technology of the present disclosure is not limited thereto. Even if there is a change in the device internal temperature, it is also possible to transmit only the data 100A that diverges from a mean value by a fixed value or more. Specifically, the data 100A is transmitted when the most recent data 100A acquired in the image forming device 10A deviates from a range determined by the data mean value and standard deviation of a predetermined number of samples acquired in the image forming device 10A.

The following describes a form in which acquired data 100A is transmitted to the shadow device 22 when the acquired data 100A is a value outside the range indicated by mean value±standard deviation×2. In this case, although omitted from illustration in the drawings, as an example, “type H” is set in the communication frequency table, and “type H” is set to “transmit value outside range indicated by mean value±standard deviation×2”.

First, the data change detection unit 62 detects the device internal temperature at 1 second intervals, and stores data 100A indicating the detected device internal temperature in the storage 11D. Here, the storage 11D continually stores 400 pieces of the data 100A as sample data. Note that when the data change detection unit 62 newly acquires data 100A indicating the device internal temperature, old data 100A is removed so that 400 pieces of the most recent data 100A are continually stored in the storage 11D.

Additionally, every time the data 100A in the storage 11D is updated, the data change detection unit 62 calculates the data mean value and standard deviation of the 400 pieces of the data 100A, and stores the calculation results in the storage 11D. Note that typical values may be stored as initial values of the mean value and standard deviation, or initial values may be set by the management terminal 50 via the shadow device 22, for example. The data change detection unit 62 also calculates the range indicated by mean value±standard deviation×2, and stores the calculation result in the storage 11D.

When the data change detection unit 62 detects that the value of acquired data 100A has changed from the data 100A last transmitted to the shadow device 22, the transmission appropriateness determination unit 64 determines that transmission is appropriate if the acquired data 100A is outside the range indicated by mean value±standard deviation×2 stored in the storage 11D.

If the transmission appropriateness determination unit 64 determines that transmission is appropriate, the data communication unit 61 transmits the acquired data 100A to the shadow device 22.

In this way, even when there is a change in the data 100A, only the data 100A that diverges from the mean value by a fixed value or more is transmitted to the shadow device 22, and thus the communication traffic may be reduced due to a reduction in the communication frequency of the data 100A. Note that the above range may also be widened automatically in cases where transmitting values outside the range indicated by mean value±standard deviation×2 would result in a higher communication frequency compared to the case of transmitting the data 100A when there is a change equal to or greater than a predetermined value from the data 100A last transmitted to the shadow device 22. With this arrangement, the communication traffic may be reduced.

In another example, as in the case in which the kind of data is accumulative data, such as the “number of jobs” accepted by the image forming device 10A, a linear approximation may be used. In this case, the data change detection unit 62 generates a linear approximation on the basis of the data 100A stored in the storage 11D, and stores the result in the storage 11D.

When the data change detection unit 62 detects that the value of acquired data 100A has changed from the data 100A last transmitted to the shadow device 22, the transmission appropriateness determination unit 64 determines that transmission is appropriate if the acquired data 100A is outside a predetermined range from the linear approximation stored in the storage 11D.

In the exemplary embodiment above, the transmission times are set for each kind of data 100A, but the present disclosure is not limited thereto. For example, the transmission times may also include times determined according to multiple kinds of data 100A collected into the same category. For example, when the image forming device 10A has toner of multiple colors (as one example, CMYK (cyan, magenta, yellow, black)), it may be desirable in some cases to send the data 100A indicating the remaining quantities at the same timing rather than sending the data 100A indicating the remaining quantities at different timings for each of the colors. In such cases, for example, when the rate of decrease in the remaining quantity of the black toner is large, the data 100A indicating the remaining quantity of the black toner is transmitted to the shadow device 22, and at this timing, the data 100A indicating the remaining quantities of the cyan, magenta, and yellow toner may be transmitted together with the data 100A indicating the remaining quantity of the black toner to the shadow device 22.

In this way, by transmitting multiple kinds of data 100A collected into the same category at the same time, multiple pieces of data 100A of the same category may be provided together.

Also, when multiple kinds of data 100A to 100C to be transmitted within a predetermined time exist, the transmission times may include a single time determined according to the multiple kinds of data 100A to 100C. For example, when the transmission appropriateness determination unit 64 determines that there are multiple kinds of data 100A to 100C to be transmitted at substantially the same time, or in other words, at slightly different timings, the data may be transmitted to the shadow device 22 together instead of being transmitted separately.

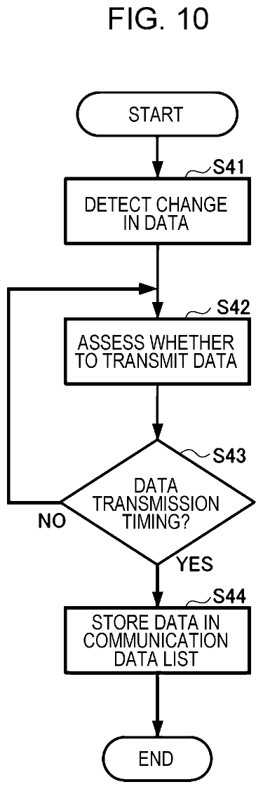

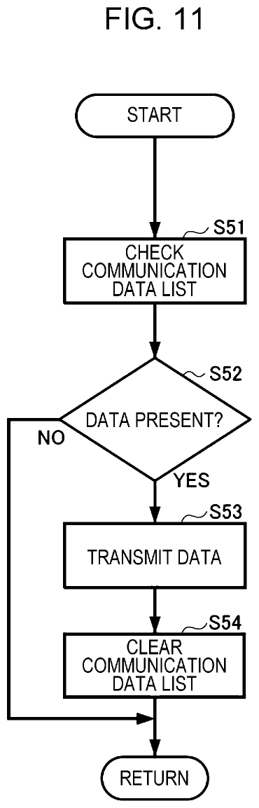

FIG. 10 is a flowchart illustrating a synchronization process 1 in the image forming device 10A in the above case, and FIG. 11 is a flowchart illustrating a synchronization process 2. Since the process in steps S41 to S43 in FIG. 10 is similar to the process in steps S21 to S23 in FIG. 8, a detailed description is omitted here.

In step S43, if the transmission appropriateness determination unit 64 determines that a timing at which to transmit acquired data 100A to the shadow device 22 has been reached, the transmission appropriateness determination unit 64 stores the acquired data 100A in a communication data list (not illustrated) stored in the storage 11D. The communication data list is a list of the data 100A that the transmission appropriateness determination unit 64 has determined to transmit to the shadow device 22.

Next, the synchronization process illustrated in FIG. 11 is performed at regular intervals. In one example, in the case where a setting has been set to send the data 100A to 100C together at 5 minute intervals, the synchronization process illustrated in FIG. 11 is performed at the timings 17:00, 17:05, 17:10, and so on.

In step S51, the data communication unit 61 checks the communication data list stored in the storage 11D. If the data 100A is not present on the communication data list (step S52; NO), the process waits until the next processing start time (5 minutes later).

On the other hand, in step S52, if the data 100A is present on the communication data list (step S52; YES), in step S53, the data communication unit 61 transmits the data 100A listed on the communication data list to the shadow device 22.

Next, in step S54, the data communication unit 61 clears the communication data list stored in the storage 11D. That is, the data 100A already transmitted to the shadow device 22 is removed from the communication data list.

In this way, multiple kinds of data 100A to be transmitted within a predetermined time is transmitted at the same time, making it possible to reduce the data communication traffic.

In the exemplary embodiment above, a multi-function device (specifically, the image forming devices 10A to 10C) is used as an example of an information processing system, but the configuration is not limited thereto. The example of an information processing system may also be a device such as a printer that only executes print processes, and an image forming device other than a multi-function device may be used. The example of an information processing system is not limited to an image forming device, may also be a personal computer, a smartphone or other terminal, or the like, and may be any device capable of communication.

In the exemplary embodiment above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

In the exemplary embodiment, the synchronization processing system is described as a configuration formed by multiple devices, but may also be a configuration formed by a single device. In the exemplary embodiment, the information processing system is described as a configuration formed by a single device, but may also be a configuration formed by multiple devices. In other words, a “system” in the exemplary embodiment may be a configuration formed by multiple devices or a configuration formed by a single device.

Also, a program realizing an exemplary embodiment of the present disclosure obviously may be provided via a communication medium, and may also be provided by being stored on a recording medium such as CD-ROM.

The present disclosure is not limited to the exemplary embodiment above, and various modifications, alterations, and improvements are possible without deviating from the gist of the present disclosure. For example, the exemplary modifications described above may also be plurally combined, as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### <Appendix>

(((1)))
   An information processing system comprising:
   at least one memory; and
   at least one processor, wherein
   the processor is configured to:
      accept, from an external device, a transmission request containing kinds of data to be transmitted and different transmission times for each kind of data; and
      transmit data to the external device on a basis of the transmission request.
(((2)))
The information processing system according to (((1))), wherein the processor is configured to transmit data on the basis of the transmission request containing, as the transmission times, times determined according to a change in data.
(((3)))
The information processing system according to (((2))), wherein the processor is configured to transmit data on the basis of the transmission request containing, as the transmission times, times determined according to a change in data acquired in the information processing system and an elapsed time since the change occurred.
(((4)))
The information processing system according to (((2))), wherein the processor is configured to transmit data on the basis of the transmission request when the change in data is that data acquired in the information processing system undergoes a predetermined change from data last transmitted to the external device.
(((5)))
The information processing system according to (((4))), wherein the processor is configured to transmit data on the basis of the transmission request when the predetermined change is that most recent data acquired in the information processing system deviates from a range determined by a data mean value and standard deviation of a predetermined number of samples acquired in the information processing system.
(((6)))
The information processing system according to (((2))), wherein, for a kind of data that is a remaining quantity of consumables consumed in the information processing system, the processor is configured to transmit data on the basis of the transmission request containing, as the transmission times, times determined according to the remaining quantity.
(((7)))
The information processing system according to (((6))), wherein, when the remaining quantity is greater than a predetermined threshold value, the processor is configured to lower a communication frequency compared to when the remaining quantity is less than or equal to the threshold value.
(((8)))
The information processing system according to (((7))), wherein, even if the remaining quantity is greater than a predetermined threshold value, the processor is configured to raise the communication frequency when a rate of decrease in the remaining quantity exceeds a predetermined threshold value.
(((9)))
The information processing system according to (((1))), wherein, for a kind of data that is a setting value set in the information processing system, the processor is configured to transmit data on the basis of the transmission request containing, as the transmission times, times determined according to the setting value.
(((10)))
The information processing system according to any one of (((1))) to (((9))), wherein the processor is configured to transmit data on the basis of the transmission request containing, as the transmission times, times determined according to a plurality of kinds of data collected into the same category.
(((11)))
The information processing system according to any one of (((1))) to (((10))), wherein, when a plurality of kinds of data to be transmitted within a predetermined time exist, the processor is configured to transmit data on the basis of the transmission request containing, as the transmission times, a single time determined according to the plurality of kinds of data.
(((12)))
An information processing program causing a computer to execute a process comprising:
accepting, from an external device, a transmission request containing kinds of data to be transmitted and different transmission times for each kind of data; and
transmitting data to the external device on a basis of the transmission request.

What is claimed is:

1. An information processing system comprising:
at least one memory; and
at least one processor, wherein:
the processor is configured to:
accept, from an external device, a transmission request containing kinds of data to be transmitted and different transmission times for each kind of data; and
transmit data to the external device on a basis of the transmission request.

2. The information processing system according to claim 1, wherein the processor is configured to transmit data on the basis of the transmission request containing, as the transmission times, times determined according to a change in data.

3. The information processing system according to claim 2, wherein the processor is configured to transmit data on the basis of the transmission request containing, as the transmission times, times determined according to a change in data acquired in the information processing system and an elapsed time since the change occurred.

4. The information processing system according to claim 2, wherein the processor is configured to transmit data on the basis of the transmission request when the change in data is that data acquired in the information processing system undergoes a predetermined change from data last transmitted to the external device.

5. The information processing system according to claim 4, wherein the processor is configured to transmit data on the basis of the transmission request when the predetermined change is that most recent data acquired in the information processing system deviates from a range determined by a data mean value and standard deviation of a predetermined number of samples acquired in the information processing system.

6. The information processing system according to claim 2, wherein, for a kind of data that is a remaining quantity of consumables consumed in the information processing system, the processor is configured to transmit data on the basis of the transmission request containing, as the transmission times, times determined according to the remaining quantity.

7. The information processing system according to claim 6, wherein, when the remaining quantity is equal to or greater than a predetermined threshold value, the processor is configured to lower a communication frequency compared to when the remaining quantity is less than the threshold value.

8. The information processing system according to claim 7, wherein, even if the remaining quantity is equal to or greater than a predetermined threshold value, the processor is configured to raise the communication frequency when a rate of decrease in the remaining quantity exceeds a predetermined threshold value.

9. The information processing system according to claim 1, wherein, for a kind of data that is a setting value set in the information processing system, the processor is configured to transmit data on the basis of the transmission request containing, as the transmission times, times determined according to the setting value.

10. The information processing system according to claim 1, wherein the processor is configured to transmit data on the basis of the transmission request containing, as the transmission times, times determined according to a plurality of kinds of data collected into the same category.

11. The information processing system according to claim 1, wherein, when a plurality of kinds of data to be transmitted within a predetermined time exist, the processor is configured to transmit data on the basis of the transmission request containing, as the transmission times, a single time determined according to the plurality of kinds of data.

12. An information processing method comprising:
accepting, from an external device, a transmission request containing kinds of data to be transmitted and different transmission times for each kind of data; and
transmitting data to the external device on a basis of the transmission request.

13. A non-transitory computer readable medium storing a program causing a computer to execute a process comprising:
accepting, from an external device, a transmission request containing kinds of data to be transmitted and different transmission times for each kind of data; and
transmitting data to the external device on a basis of the transmission request.
